(19) United States
(12) Patent Application Publication
(10) Pub. No.: US 2016/0149669 A1
(43) Pub. Date: May 26, 2016

(54) Data Transfer System

(71) Applicants: Mark Meyers, Thousand Oaks, CA (US); Jorge Freitas, Maple Ridge (CA)

(72) Inventors: Mark Meyers, Thousand Oaks, CA (US); Jorge Freitas, Maple Ridge (CA)

(21) Appl. No.: 14/951,287

(22) Filed: Nov. 24, 2015

Related U.S. Application Data
(60) Provisional application No. 62/083,831, filed on Nov. 24, 2014.

(51) Int. Cl. H04L 1/00; G06F 11/16

(52) U.S. Cl. CPC H04L 1/0073; G06F 11/1641; G06F 11/1625

(57) ABSTRACT

A method for transferring data, more particularly, over a low energy connection such as a Bluetooth Low Energy connection, includes dividing a source data into a plurality of data chunks, associating each data chunk with a verification data such as a checksum, transferring the data chunks and verifying that each data chunk was received without error, using the checksum. The method may also include providing a verification data for the source data, transferring it before and after all the data chunks, and verifying that all the data chunks and thus the entire source data was received.

### CROSS REFERENCE TO RELATED APPLICATIONS

The application claims the benefit of United States Provisional Application No. 62/083831, filed on Nov. 24, 2014, which is incorporated by reference herein in its entirety.

### FIELD OF INVENTION

The invention is related to a system and method for transferring data.

### BACKGROUND OF THE INVENTION

The invention relates generally to a system and method for high-speed wireless data transfer, more specifically of large data files, to or from a device such as a toy, including a plush doll.

Large data files typically take a long time to transfer wirelessly, especially via BTLE (Bluetooth Low Energy) data connection. For example, a 1 MB (Megabyte) file may take approximately 8 minutes. With technological advances in devices such as phones, cameras, computers, etc., users are accustomed to higher quality images, videos, audios, etc. and faster speeds in processing or transferring data. Moreover, when files are transferred to a device without high-speed processors (such as a doll), the data transfer typically takes a longer time. However, whereas the file size increases, users typically wish for quicker transfers and may be dissatisfied.

Accordingly, it is desirable to provide an improved method and system for transferring large data files to a device such as a toy overcomes drawbacks and inadequacies of known methods and systems.

### SUMMARY OF THE INVENTION

The present invention is directed to a method for transferring data at an increased rate, more particularly large data files. One embodiment of the invention comprises separating the data file into a plurality of data chunks and individually transmitting each data chunk, preferably in sequence. Using the invention, the individual files transmitted have significantly reduced sizes, thus expediting the process. Each data chunk includes a checksum having verification information, which is confirmed in order to ensure proper data transfer without data corruption. The checksum of each data chunk may be verified for each data chunk as it is received, or after receiving two or more data chunks. The checksums of all the data chunks may be verified against a master checksum of the source data file prior to combining the data chunks to form the complete transferred data file. The original data file may include a master checksum sent in the header and/or footer of the file, and thus before the first data chunk and after the final data chunk.

In accordance with an embodiment of the invention, each data chunk comprises 20 bytes of memory and is placed in a specific “Characteristic Attribute” representing the type of operation to be performed on the data chunk. For example, the Characteristic Attribute may be to send audio data to a device paired via Bluetooth. Alternatively, the Characteristic Attribute may be to receive data from or issue a command to a device. The data chunks are placed into Characteristic Attributes preparing for transmission. A unique code, such as a checksum, is layered into each data chunk and is recombined by the receiving device to create a verification checksum, which is verified against the master checksum of the original data file.

The invention is also directed toward a system for transferring data at an expedited rate, the system comprising a source device for dividing a source data into a plurality of data chunks and generating a checksum for each of said plurality of data chunks. The system preferably also includes a receiving device for receiving the plurality of data chunks and verifying the checksum for each data chunk received to confirm that the data chunks were received without error. The receiving device preferably combines the data chunks and confirms that all the data chunks were received without error and processes the complete data. The source device may generate a master checksum for the source data, and the receiving device may verify the master checksum after receiving all the data chunks, more preferably by verifying all the checksums received against the master checksum.

In accordance with one embodiment, the source device may alternatively capture the source data while and transferring the data chunks. In accordance with yet another embodiment the receiving device may process the data chunks while receiving them, rather than after the data transfer is completed.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawings, in which:

FIG. 1 is an illustration of a block of data being transferred between devices in accordance with an embodiment of the invention;

FIG. 2 is an illustration of the breakdown of the block of data of FIG. 1 into data chunks; and

FIG. 3 is an illustration of the data chunks of FIG. 2 with respect to the step of verifying the checksum information of the data chunks.

### DETAILED DESCRIPTION OF THE PREFERRED EMBODIMENTS

The invention is generally directed to a method for high-speed data transfer over low-energy connections such as BTLE (Bluetooth Low Energy) connections. The data may comprise, by way of non-limiting example, audio, image, video, and/or control data, and may be transferred from a mobile device such as a cellular phone or tablet to a receiving device such as a toy, and/or vice versa.

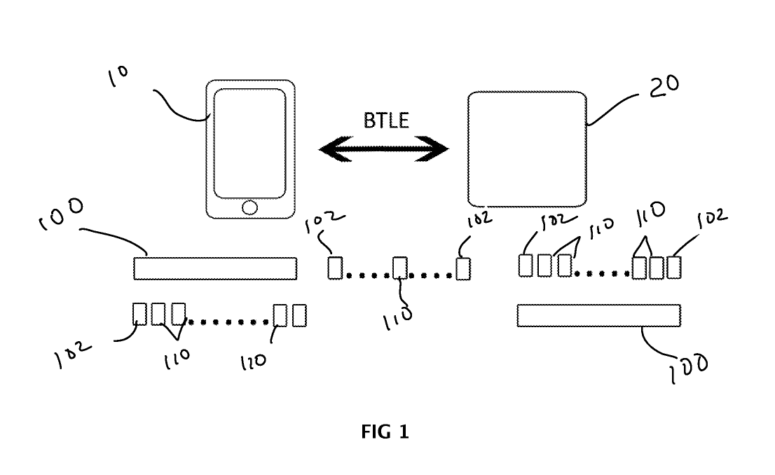

Referring to FIG. 1, an example of a system utilizing the data transfer method includes a source device 10 and a receiving device 20, each being Bluetooth-enabled, capable of connecting to each other via BTLE. In accordance with one embodiment, source device 10 is a mobile device, such as a cellular phone, tablet, handheld gaming device, etc., and receiving device 20 is a plush doll having a mechanism for playing audio data. The receiving device 20 may include a speaker for playing the audio or may be connected, either via a physical wire or a wireless connection, to an external speaker.

Preferably, the transfer of data can be in either direction, whether from the source device 10 to the receiving device 20, vice versa, or both. Thus, both the source device 10 and the receiving device 20 may function as both the source and the recipient. Preferably, both the source device 10 and the receiving device 20 have a microphone for capturing audio as well as a mechanism for playing audio, so that both devices 10, 20 may be used to capture audio or video data and transfer such data to the other device. In accordance with an embodiment of the invention, an audio file such as a voice message is transmitted to a plush doll, which the recipient may listen to via the doll. The recipient may reply to the sender by using the doll to capture a voice message and send the response voice message to the sender utilizing the same transfer method described herein. Thus, the receiving device would become the source device and the source device would become the receiving device in the response transmission. Receiving device 20 may further include a storage medium for storing the recording or other files, or it may play the recording while receiving the data, without saving it as a file. Source device 10 may further transmit the recording while capturing it, rather than transmitting it after the entire recording has been captured. It is to be understood that whereas a voice message is described as an example, other files such as other audio files, video files, other media files or non-media files are contemplated for this invention.

In order to accomplish high-speed data transfer via lower low energy connections, an embodiment of the invention includes selectively compressing the data, splitting up the data into data chunks, and providing verification information to the data chunks. Because the chunks of data are smaller than the source data file, preferably around 20 bytes each, each chunk of data may be transferred at a faster speed than a large data file which may be several kilobytes, megabytes, gigabytes or perhaps even larger in size. Currently available methods of data transmission generally include transmitting data organized as a single continuous block in a single transfer operation, without any form of compression or transformation. Not only is such a method slower, the single transfer operation does not achieve a transmission speed necessary to transfer large data files quickly enough to achieve real time usage of certain data types such as audio or video, as embodiments of the invention provide.

An embodiment of the method provides continuous transmission of data. By continuously transmitting smaller data chunks, receiving devices without a storage medium or with a low-capacity storage medium may be able to receive files exceeding its storage capacity by processing the data chunks as it receives them. A data chunk received and processed may be discarded after processing, or it may be stored briefly until it is replaced by another data chunk. Such a function would not be possible if the source data file was transmitted in a single transfer operation in accordance with currently known methods.

Generally, in accordance with an exemplary embodiment of the invention, the source data 100 is prepared for transmission. More specifically, the data is evaluated to determine if it should be compressed, and if compression is deemed desirable, the data is compressed. If it is determined that the data will not be compressed, the compression step is skipped, and the subsequent steps are performed. The compression method used may vary depending on the type of data to be transmitted and the compression ratio required. For example, audio data may use a different compression method than video data. In addition, the compression ratio may be adjusted to further reduce data size, when the data type allows for loss of quality playback, such as audio and video data types.

The data file is then split into a plurality of smaller discrete packets of data, referred to herein as data chunks 110. The data chunks are then placed into Characteristic Attributes to prepare them for transmission. Preferably, the data chunks 100 are 100 bytes or less, more preferably around 20 bytes in size. More preferably, most of the data chunks 100 of the same source data file are consistent in size.

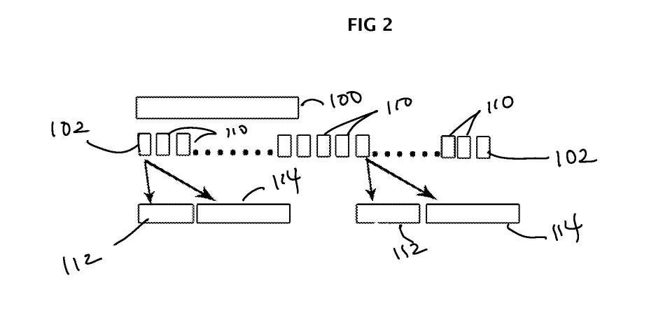

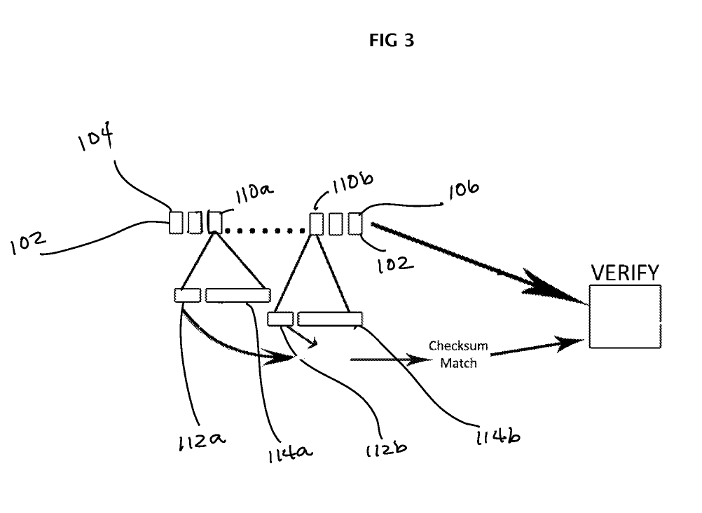

Once the source data 100 is split into data chunks 110, checksum values are calculated and included with each data chunk 110. A checksum is a mechanism for determining the validity of digital data, used when confirming if the received data has become corrupted during the transmission process. By providing a checksum 112 for each data chunk 110, the invention provides the option of determining validity of each data chunk 110 as each data chunk 110 is received, or after the transfer process has been completed in its entirety, as an application specific design choice. An example of the checksum 112 is a numerical value generated by a standard checksum algorithm known in the art. In accordance with an embodiment of the invention, the source data 100 includes a “master checksum” 102 in its header 104 and footer 106 as illustrated in FIG. 3, and each data chunk 110 includes its own checksum 112 separated from the chunk data 114, as illustrated in FIGS. 2-3. As shown in FIG. 3, a first data chunk 110a has a first checksum 112a and a first chunk data 114a, and a second data chunk 110b has a second checksum 112b and a second chunk data 114b.

The data chunks 110 are transferred from the source device 10 to the receiving device 20. Once the receiving device 20 receives a data chunk 110, the checksum 112 of the data chunk is verified to ensure each data chunk 110 is received without error. If a data chunk 110 fails the error detection step, the respective data chunk 110 is retransmitted from the source device 10 and replaces the failed data chunk 110. The retransmission may occur either immediately after receiving the data chunk 110, or after all the subsequent data chunks have been received. Furthermore, the use of checksums and verifying transmissions may indicate BTLE signal strength. More specifically, repeated checksum failure may indicate poor BTLE signal strength, and may trigger premature termination of the transfer operation for certain applications. Once all the data chunks 110 are received, the checksum 112 of all the data chunks 110 are compared to the master checksum 102 of the original source data 100 to ensure all of the data chunks 110 have been received.

Referring to FIGS. 2-3, an example of the data transfer method in accordance with an embodiment of the invention includes the following steps:

1. Determine the source of the data to be transferred. The data may reside on a storage medium or it may be data captured or generated in real-time during the transfer, for example an audio or video as it is being recorded.

2. Select a compression algorithm depending on the minimum acceptable data fidelity required by the receiving device. The source data may be compressed or uncompressed. Data of a large size, such as audio, may be compressed before transmission. Compression is desired in order to achieve the high data throughput needed to perform simultaneous transmission and playback of audio data. However, small amounts of data, which can be fully transmitted in a small number of packets, such as 1-4 packets, do not require compression. For example, program commands used to trigger actions on the BTLE connected device would likely be small amounts of data and would not be compressed.

3. If the data file is located on a storage medium, compress and prepare source data and prepare for the transfer. If the data is captured or generated in real-time, initialize and prepare the real-time mechanism to feed the data file to the transfer.

4. Provide a master checksum for the data file.

5. Split the data file into data chunks.

6. Provide a checksum for each data chunk.

7. Establish a BTLE connection between the source device and the receiving device and initiate high-speed transfer. The connection parameters may depend on the capabilities of each device, due to variations of the Bluetooth chipset, the Operating System running on each device, or other factors.

8. Transmit data chunks from the source device to the receiving device.

9. Verify the checksum of each data chunk to confirm each data file is received without error.

10. Combine the data chunks to form the original data file.

11. Verify the combined checksums against the master checksum to ensure every data chunk was received and without error.

12. Once all the data chunks are received and verified, the BTLE connection may either be terminated or left to remain active, as a matter of application specific design choice.

Preferably, a custom communication protocol between the source device and the receiving device manages the high-speed data transfer, including state transitions that determine when to start, pause, continue and finalize the data transfer.

The receiving device preferably includes software, firmware, mobile application or other suitable means for processing the incoming data chunks. The receiving device preferably receives the data chunks in the order in which they are transmitted. The receiving device may continuously process the incoming data chunks during the data transfer as the data chunks are received, or it may store and decode all the data chunks after the transfer is completed. If the data chunks are processed as they are received, for media data such as audio or video, the media data may be played on the receiving device while the data chunks are being received. More particularly, a voice message being transmitted may be played on the receiving device continuously, like a streaming device, as the data chunks are being received. As mentioned above, such a configuration may be desirable for receiving devices without a storage medium or with a low-capacity storage medium, which would process the data chunks without saving them or which would save them briefly. Transmitting data chunks instead of the complete data file may also permit the transmittance of data as it is being captured. For example, audio or video data may be transmitted as is it being captured on a phone or other device capable of capturing such data.

In one embodiment of the invention, a GATT Profile specifies the structure in which profile data is exchanged. More specifically, GATT generally defines the way two Bluetooth Low Energy devices transfer data back and forth using concepts called Services and Characteristics used in a profile. It is typically a part of the Bluetooth Standard utilized by the application software and device firmware to perform Bluetooth Low Energy operations. The top level of the hierarchy is a profile composed of one or more services necessary to fulfill a use case, wherein a service is composed of characteristics or references to other services. Each characteristic contains a value and may contain optional information about the value. The service and characteristic and the components of the characteristic (i.e., value and descriptors) contain the profile data and are all stored in attributes.

The GATT profile is preferably used to send informational attributes. The embodiment of the GATT data transfer system is broken into 3 unique parts: Data preparation, GATT update protocol, and data reconstruction. The GATT protocol update rate is preferably set at the minimum allowable value, which will send updated characteristics across the Bluetooth 4.0 protocol at an increased rate.

Other alterations may be made without deviating from the scope of the invention. Accordingly, the system and method, the use, steps, order of steps, etc. may be varied as a matter of application specific design choice without deviating from the scope of the invention. For example, additional data types or compression techniques could be employed to further reduce the transmitted data size and decrease the transfer time. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

We claim:

1. A method of transmitting data, the method comprising:
analyzing a source data to determine a compression requirement of the source data;
generating a master checksum for the source data;
splitting the source data into a plurality of data chunks;
generating a chunk checksum for each data chunk;
transmitting the plurality of data chunks from a source device to a receiving device;
validating each data chunk utilizing the chunk checksum;
transmitting the master checksum from a source device to a receiving device; and
comparing the chunk checksums with the master checksum to validate the plurality of data chunks received by the receiving device.

2. The method of claim 1, further comprising compressing the source data prior to splitting the source data.

3. The method of claim 1, further comprising identifying a corrupted data chunk at the receiving device, and retransmitting said data chunk from the source device to the receiving device.

4. The method of claim 1, further comprising processing the data chunks at the receiving device.

5. The method of claim 1, further comprising processing each data chunk at the receiving device as the data chunk is received.

6. The method of claim 1, further comprising receiving all of said plurality of data chunks at the receiving device prior to validating the chunk checksums.

7. The method of claim 1, further wherein transmitting the master checksum comprises transmitting the master checksum before and after the plurality of data chunks.

8. The method of claim 1, further comprising providing a first of said chunk checksums in a header of a first of said data chunks.

9. The method of claim 1, wherein transmitting the data chunks comprises transmitting the data chunks via a low energy connection.

10. The method of claim 1, wherein transmitting the data chunks comprises transmitting the data chunks via a Bluetooth Low Energy connection.

11. The method of claim 1, wherein the master checksum and the chunk checksums each includes a numerical value generated by a standard checksum algorithm.

12. The method of claim 1, wherein the source data is continuously generated by the source device concurrently while the data chunks are being transmitted to the receiving device.

13. The method of claim 1, further comprising continuously generating the source data concurrently while transmitting the data chunks to the receiving device.

14. The method of claim 1, further comprising processing the data chunks at the receiving device while transmitting the data chunks to the receiving device.

15. The method of claim 1, wherein the source data is an audio or video data.

16. A method of transmitting data, the method comprising:
splitting a source data into a plurality of data chunks;
generating a chunk checksum for each data chunk;
transmitting the plurality of data chunks from a source device to a receiving device; and
validating each data chunk utilizing the chunk checksum to ensure the data chunk was not corrupted.

17. The method of claim 16, further comprising compressing the source data prior to splitting the source data.

18. The method of claim 16, further comprising generating a master checksum for the source data and transmitting the master checksum to the receiving device.

19. The method of claim 18, further comprising transmitting the master checksum before and after the plurality of data chunks.

20. The method of claim 18, further comprising validating the chunk checksums against the master checksum.
